(19) United States
(12) Patent Application Publication
(10) Pub. No.: US 2006/0232019 A1
(43) Pub. Date: Oct. 19, 2006

(54) Encapsulated back-up system for use with seal system

(76) Inventors: Hubert F. Garrison, Deer Park, TX (US); Douglas J. Lehr, The Woodlands, TX (US); Gabriel Slup, Spring, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/109,574

(22) Filed: Apr. 19, 2005

(51) Int. Cl. F16L 17/06

(52) U.S. Cl. 277/611

(57) ABSTRACT

Disclosed is an anti-extrusion assembly used in conjunction with an expandable packing device. The assembly comprises two slotted metallic rings encapsulated in a non-metallic material. The slotted metallic rings prevent extrusion of the sealing mechanism of the expandable packing device as the device is set in a wellbore casing. The encapsulating non-metallic material protects the metallic rings from damage as the packing device is run into the wellbore. In an alternative embodiment, the anti-extrusion assembly comprises a crimped metallic ring flanked by non-metallic rings. As with the slotted metallic rings, the single crimped metallic ring prevents extrusion of the sealing mechanism of the expandable packing device as it is set in the wellbore casing.

### BACKGROUND OF THE INVENTION

Expandable packers and bridge plugs are commonly used in the oil and gas industry to seal or close off an annular area in a wellbore casing. Theses packers or bridge plugs typically include a centrally located sealing member that is cylindrically shaped and constructed of rubber or some other elastomeric material. The outer diameter of the sealing member is typically smaller that the inner diameter of the corresponding casing such that the packer or bridge plug can be easily inserted and positioned at the desired location within the casing.

Once correctly positioned, the activation of the packer or bridge plug typically results in a longitudinal compression of the sealing member such that the sealing member is forced outwardly into contact with the casing, effectively sealing the annular area. The sealing member is held in this compressed state by the simultaneous setting of a series of slips. The slips for permanent packers or bridge plugs are typically located above and below the sealing member and, when activated, are cammed outwardly against the casing to anchor the packer or bridge plug in place. Other packers or bridge plugs, particularly the retrievable variety, may have only a single set of slips.

Anti-extrusion or “back-up” assemblies, typically in the form of solid or slotted rings, are positioned adjacent to the sealing assembly, between the sealing assembly and the slips. These back-up assemblies are designed to expand radially and prevent extrusion of the sealing member during activation of the packer or bridge plug. However, the back-up assemblies, particularly the slotted variety, are susceptible to damage when the packer or bridge plug is being run downhole.

Damage to the back-up assemblies can occur due to wellbore fluid rushing past the packer or bridge plug, or due to contact with the casing (especially at transition points such as the transition between the casing and a liner). Contact with the casing often occurs when running the packer or bridge plug through a transition point, such as the entrance to a liner. Damage to the back-up assembly can cause the packer or bridge plug to set prematurely (i.e., at a depth that is less than intended) or leak prematurely. When this happens, the packer or bridge plug must be either retrieved (if it is a retrievable type), or destructively removed from the casing (if it is a permanent type). Both of these alternatives are costly and time consuming.

Accordingly, a need has arisen for a back-up assembly design that protects against damage and eliminates the likelihood of the corresponding packer or bridge plug setting prematurely or leaking after setting. The following invention addresses those needs.

### SUMMARY OF THE INVENTION

This invention relates to an anti-extrusion assembly used in conjunction with expandable packing devices. More particularly, this invention relates to a back-up assembly used to prevent the extrusion of a sealing member on downhole packers and bridge plugs.

In a first embodiment of the present invention, the back-up assembly comprises an outer metallic ring exhibiting a generally conical shape and including a flat shelf at the narrow end of the outer metallic ring. The shelf includes a longitudinal bore, which exhibits a hexagonal or other suitable polygonal shape. The outer metallic ring includes a series of longitudinal slots, which extend along the entire length of the conical portion of the outer metallic ring, and partially into the shelf. The slots effectively form a series of “petals” in the areas located between the slots.

The back-up assembly further comprises an inner metallic ring exhibiting a generally conical shape and including a flat shelf at the narrow end of the inner metallic ring. The shelf of the inner metallic ring includes a longitudinal bore, which, like the longitudinal bore of the outer metallic ring, exhibits a hexagonal or similar polygonal shape. The inner metallic ring includes a series of longitudinal slots, which extend along the entire length of the conical portion of the inner metallic ring, and partially into the shelf. As with the outer metallic ring, the slots effectively form a series of petals in the areas located between the slots.

The inner metallic ring is placed within the outer metallic ring such that the outer diameter of the inner metallic ring abuts the inner diameter of the outer metallic ring. The inner metallic ring is arranged within the outer metallic ring such that the respective slots and corresponding petals do not overlap. This results in the slots of the inner metallic ring being “covered” by the petals of the outer metallic ring, and vice versa. While the respective slots and petals are not aligned, the opposite is true for the longitudinal bores of the inner metallic ring and the outer metallic ring.

Once the metallic rings are properly arranged, they are encapsulated in an non-metallic material. The encapsulating material does not distort the overall geometry of the metallic rings, including the shape of the longitudinal bores. Rather, the encapsulating material serves to protect the back-up assembly from damage and premature setting due to inadvertent contact with the casing and/or other problems associated with running a packer or bridge plug into a wellbore.

Once encapsulated, one or more back-up assemblies of the present invention are placed onto the mandrel of a packer or bridge plug. The encapsulated back-up assemblies are typically located on either side of a sealing member. The packer or bridge plug is then lowered into a wellbore. Once correctly positioned, the packer or bridge plug is activated, which typically results in the sealing member being forced outwardly into contact with the wellbore casing. Simultaneously, the encapsulated back-up assemblies flare out and expand radially and prevent extrusion of the sealing member. The offsetting alignment of the slots and petals of the outer metallic ring and inner metallic ring leaves no uncovered “gaps.” Accordingly, as the sealing member expands, it is prohibited from extruding past the back-up assemblies, and is instead forced into sealing contact with the wellbore casing.

In a second embodiment of the present invention, the back-up assembly comprises a flat metallic disc. The metallic disc includes a longitudinal bore, which exhibits a hexagonal or other suitable polygonal shape. The metallic disc includes a series of slots, which extend radially from the outer diameter of the metallic disc towards the longitudinal bore. The slots effectively form a series of petals in the areas located between the slots. The flat metallic disc is then “crimped” and formed into a metallic ring. The metallic ring exhibits a generally conical shape, but includes a flat shelf extending radially inward at the narrow end of the metallic ring. In this crimped state, the petals overlap each other, thereby effectively eliminating the slots.

The back-up assembly further comprises a non-metallic inner ring. The non-metallic inner ring exhibits a generally conical shape and includes a longitudinal bore, which also exhibits a hexagonal or similar polygonal shape. The inner non-metallic ring is placed within the metallic ring such that the outer diameter of the inner non-metallic inner ring abuts the inner diameter of the metallic ring. As the longitudinal bores exhibit the same geometry, they are aligned such that their respective shapes effectively mirror each other. The back-up assembly additionally comprises a non-metallic outer ring. The non-metallic outer ring is placed around the outer diameter of the metallic ring. While not entirely encapsulating the metallic ring as in the first embodiment, the non-metallic outer ring of this embodiment extends the entire longitudinal length of the metallic ring, including the shelf portion, and will flow through any gaps between the petals in the metallic ring. The three rings comprise the complete back-up assembly.

Once complete, one or more back-up assemblies of the present invention are placed onto the mandrel of a packer or bridge plug. The back-up assemblies are typically located on either side of a sealing member. The packer or bridge plug is then lowered into a wellbore. Once correctly positioned, the packer or bridge plug is activated, which typically results in the sealing member being forced outwardly into contact with the wellbore casing. Simultaneously, the back-up assemblies flare out and expand radially and prevent extrusion of the sealing member. The overlapping of the “crimped” petals leaves little or no uncovered “gaps” as the metallic rings are flared out. Accordingly, as the sealing member expands, it is prohibited from extruding past the back-up assemblies, and is instead forced into sealing contact with the wellbore casing.

In a third embodiment of the present invention, the composition of the back-up assembly is identical to that of the second embodiment, except that an additional anti-extrusion ring has been added. The anti-extrusion ring is added to improve the anti-extrusion capability of the back-up assembly at higher wellbore temperatures. The anti-extrusion ring may either be embedded into the non-metallic inner ring at a point adjacent to the sealing member, or at a point adjacent to the metallic ring. Alternatively, the anti-extrusion ring may be embedded into the non-metallic outer ring.

Additional objects and advantages of the invention will become apparent as the following detailed description of the preferred embodiment is read in conjunction with the drawings.

### BRIEF DESCRIPTION OF THE DRAWINGS

FIGS. 1a, 1b, and 1c illustrate multiple views of the outer metallic ring component of the back-up assembly of the present invention.

FIGS. 2a, 2b, and 2c illustrate multiple views of the inner metallic ring component of the back-up assembly of the present invention.

FIGS. 3a and 3b illustrate multiple views of the encapsulated back-up assembly of the present invention.

FIG. 4a illustrates the flat metallic disc component of the back-up assembly of the present invention.

FIG. 4b illustrates the crimped metallic ring component of the back-up assembly of the present invention.

FIGS. 5a, 5b, and 5c illustrate multiple views of the non-metallic inner ring component of the back-up assembly of the present invention.

FIGS. 6a and 6b illustrate multiple views of the complete back-up assembly of the present invention.

FIG. 7 illustrates the anti-extrusion ring component of the back-up assembly of the present invention.

FIG. 8 illustrates an alternative embodiment of the anti-extrusion ring component of the back-up assembly of the present invention.

FIG. 9 illustrates another alternative embodiment of the anti-extrusion ring of the complete back-up assembly of the present invention.

### DESCRIPTION OF ILLUSTRATIVE EMBODIMENTS

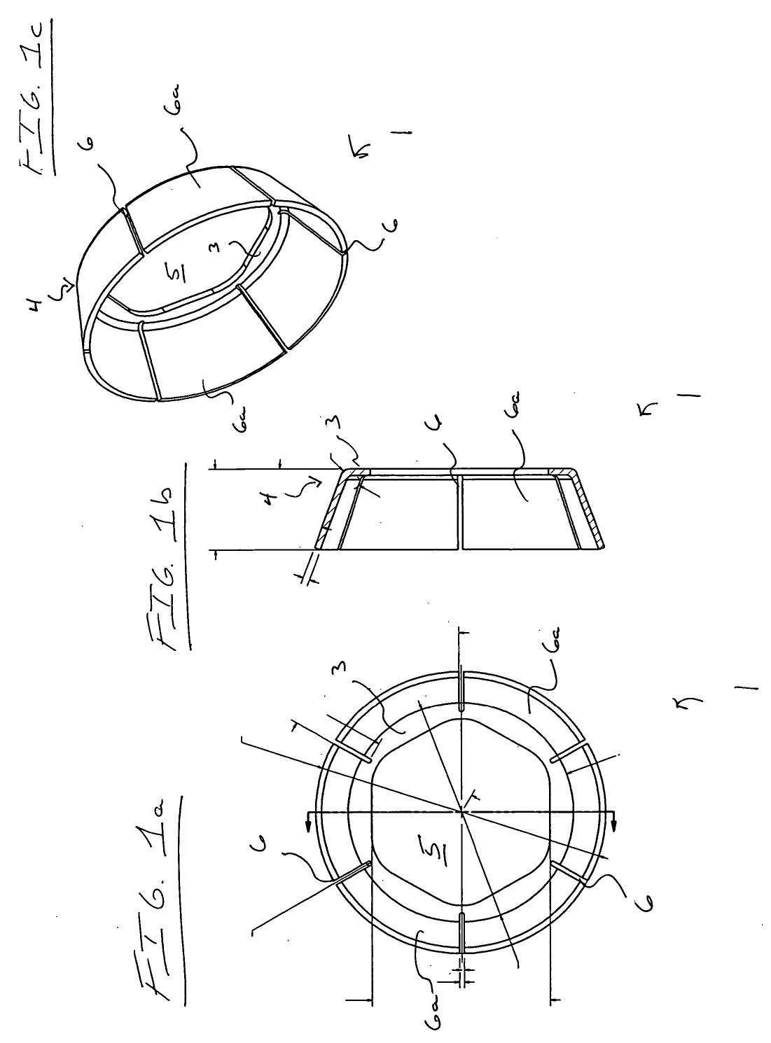

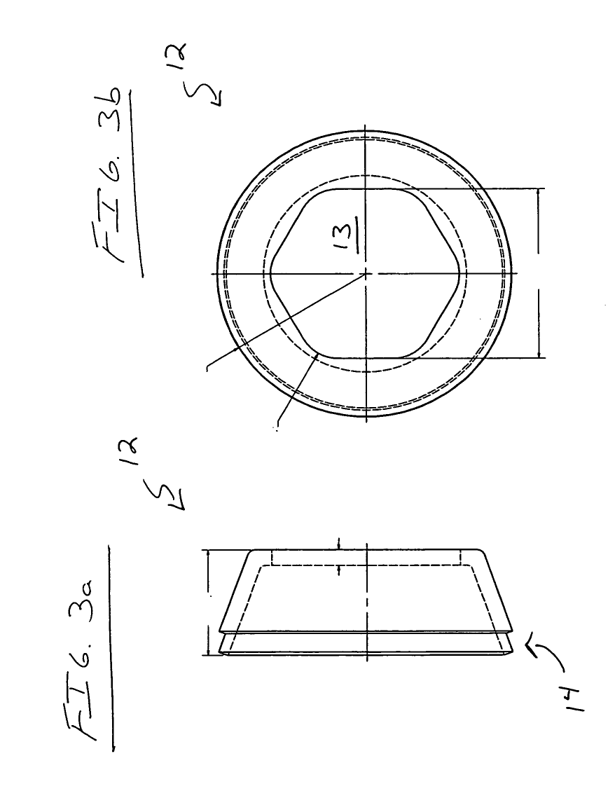

FIGS. 1(a-c) through FIGS. 3(a-b) illustrate a first embodiment of the back-up apparatus of the present invention. FIGS. 1a, 1b, and 1c show multiple views of an outer metallic ring (1). The outer metallic ring (1) exhibits a generally conical shape, but includes a flat shelf (3) extending radially inward at the narrow end (4) of the outer metallic ring (1). The outer metallic ring (1) is preferably composed of steel, but any suitable metal may be used. In an alternative embodiment, the outer metallic ring (1) may be composed of a non-metallic material such as sheet-molding compound, however any suitable non-metallic material may be used.

The shelf (3) of the outer metallic ring (1) includes a longitudinal bore (5), which in this embodiment exhibits a hexagonal shape, but may exhibit any other suitable polygonal shape. The shape of the bore (5) is dependent on the shape of the corresponding mandrel (not shown) of the packer or bridge plug (not shown) onto which the back-up apparatus will eventually be placed.

The outer metallic ring (1) includes a series of longitudinal slots (6), which extend along the entire length of the conical portion of the outer metallic ring (1) and partially into the shelf (3). The slots (6) extend completely through the diameter of the outer metallic ring (1). The slots (6) effectively form a series of “petals” (6a) in the areas located between the slots (6). In FIGS. 1a and 1c, six slots (6) and corresponding petals (6a) are shown spaced equally around the outer metallic ring (1). However, a different number of slots (6) and petals (6a) spaced in a different manner may also be used.

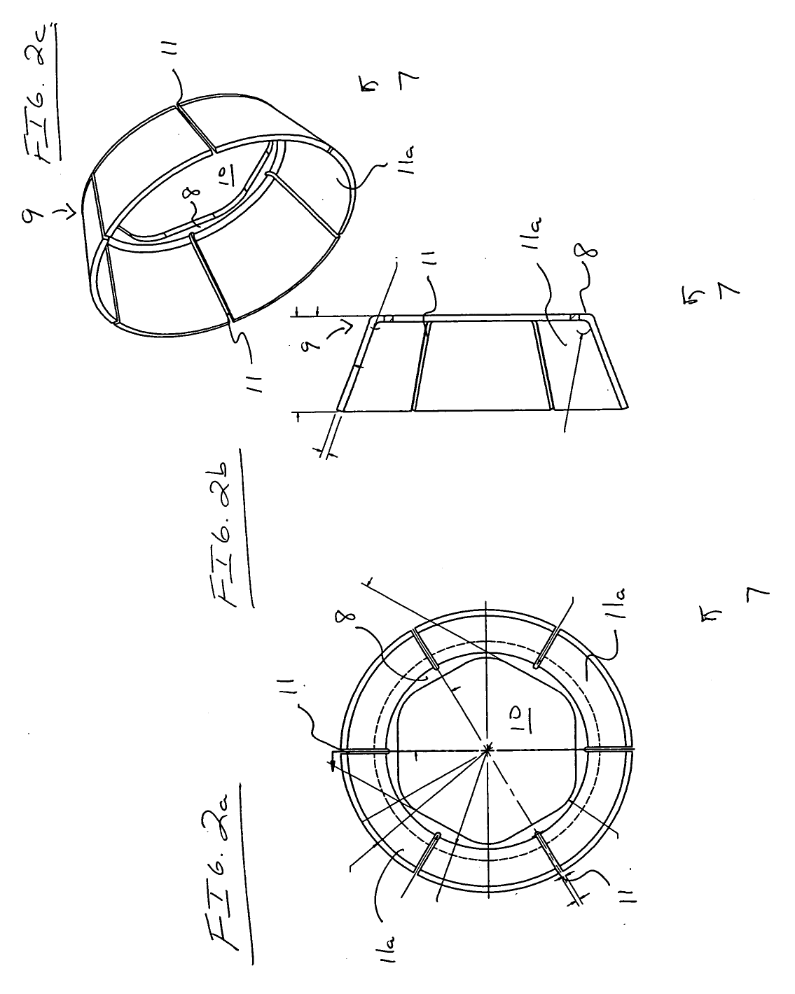

FIGS. 2a, 2b, and 2c show multiple views of an inner metallic ring (7). As with the outer metallic ring (1), the inner metallic ring (7) exhibits a generally conical shape and includes a flat shelf (8) extending radially inward at the narrow end (9) of the inner metallic ring (7). The inner metallic ring (7) is preferably composed of steel, but any suitable metal may be used. In an alternative embodiment, the inner metallic ring (7) may be composed of a non-metallic material such as a sheet-molding compound, however any suitable non-metallic material may be used.

As with the outer metallic ring (1), the shelf (8) of the inner metallic ring (7) includes a longitudinal bore (10), which exhibits a hexagonal shape, but may exhibit any other suitable polygonal shape. It is preferable for the shape of the longitudinal bore (10) of the inner metallic ring (7) to match the shape of the longitudinal bore (5) of the outer metallic ring (1). As before, the shape of the bore (10) is dependent on the shape of the corresponding mandrel (not shown) of the packer or bridge plug (not shown) onto which the back-up apparatus will eventually be placed.

The inner metallic ring (7) includes a series of longitudinal slots (11), which extend along the entire length of the conical portion of the inner metallic ring (7) and partially into the shelf (8). The slots (11) extend completely through the diameter of the inner metallic ring (7). As with the outer metallic ring (1), the slots (11) effectively form a series of petals (11a) in the areas located between the slots (11). In FIGS. 2a and 2c, six slots (11) and corresponding petals (11a) are shown spaced equally around the inner metallic ring (7). However, as with the outer metallic ring (1), a different number of slots (11) and petals (11a) spaced in a different manner may also be used.

The inner metallic ring (as shown in FIG. 2(a-c)) is placed within the outer metallic ring (as shown in FIG. 1(a-c)) such that the outer diameter of the inner metallic ring (7) abuts the inner diameter of the outer metallic ring (1). The inner metallic ring (7) is arranged within the outer metallic ring (1) such that the respective slots (6, 11) and corresponding petals (6a, 11a) do not overlap (i.e., the slots and petals are offset). This results in the slots (11) of the inner metallic ring (7) being “covered” by the petals (6a) of the outer metallic ring (1), and vice versa. This arrangement becomes apparent when comparing the position of the respective slots (6, 11) and petals (6a, 11a) of the metallic rings in FIGS. 1(a-c) and FIGS. 2(a-c).

While the respective slots (6, 11) and petals (6a, 11a) are not aligned, the opposite is true for the longitudinal bores (5, 10) of the inner metallic ring (7) and the outer metallic ring (1). The longitudinal bores (5, 10) preferably exhibit the same geometry (as described above) and are aligned such that their respective shapes effectively mirror each other. This allows for the fully assembled back-up assembly to be placed onto the corresponding mandrel (not shown) of the packer or bridge plug (not shown). The non-circular geometry of the longitudinal bores (5, 10) effectively anchors or locks the back-up assembly in place if the packer or bridge plug is removed from the wellbore by milling or drilling.

Once properly aligned, the metallic rings (1, 7) are secured together by any suitable means, but preferably by spot welding. The metallic rings (1, 7) are then encapsulated in an elastomeric material (such as nitrile rubber), a non-elastomeric polymer (such as PTFE), or a combination of the two materials. The encapsulating materials may be selected based on a variety of factors, such as stiffness or abrasion resistance. In an alternative embodiment, only one of the metallic rings (1, 7) is encapsulated, while the other metallic ring (1, 7) is left unencapsulated. The encapsulation of one of the metallic rings (1, 7) is accomplished prior to securing the two metallic rings (1, 7) together. Preferably, in this alternative embodiment, the outer metallic ring (1) is the encapsulated ring.

Multiple views of the encapsulated back-up assembly (12) are shown in FIGS. 3a and 3b. As shown, the encapsulating material does not distort the overall geometry of the metallic rings, including the shape of the longitudinal bores (13). Rather, the encapsulating material serves to protect the back-up assembly from damage and premature setting due to inadvertent contact with the casing and/or other problems associated with running a packer or bridge plug into a wellbore.

To construct a typical packer or bridge plug as referenced herein, one or more back-up assemblies (12) of the present invention are placed onto the mandrel (not shown) of the packer or bridge plug (not shown). The placement onto the mandrel is facilitated by the corresponding geometries of the mandrel and the longitudinal bores (13), as described above. The encapsulated back-up assemblies (12) are typically located on either side of a sealing member (not shown), with the wide end (14) of the back-up assemblies facing the sealing member. The packer or bridge plug is further constructed using additional components such as slips, cones, locking rings, etc., all of which are known to those of skill in the art and thus are not described or illustrated here.

Once constructed, the packer or bridge plug is lowered into a wellbore. As noted above, the encapsulation of the back-up assemblies (12) prevents damage and helps to ensure the packer or bridge plug reaches the proper depth. Once correctly positioned, the packer or bridge plug is activated (the activation sequence depending on the type of packer or bridge plug), which typically results in the longitudinal compression of the sealing member such that the sealing member is forced outwardly into contact with the wellbore casing. Simultaneously, the encapsulated back-up assemblies (12) of the present invention flare out and expand radially (thereby deforming and typically destroying the encapsulating material) and prevent extrusion of the sealing member. With reference to FIGS. 1(a-c) through FIGS. 3(a-b), the offsetting alignment of the slots (6, 11) and petals (6a, 11a) of the outer metallic ring (1) and inner metallic ring (7) leave no uncovered “gaps.” Accordingly, as the sealing member (not shown) expands, it is prohibited from extruding past the back-up assemblies (12), and is instead forced into sealing contact with the wellbore casing (not shown).

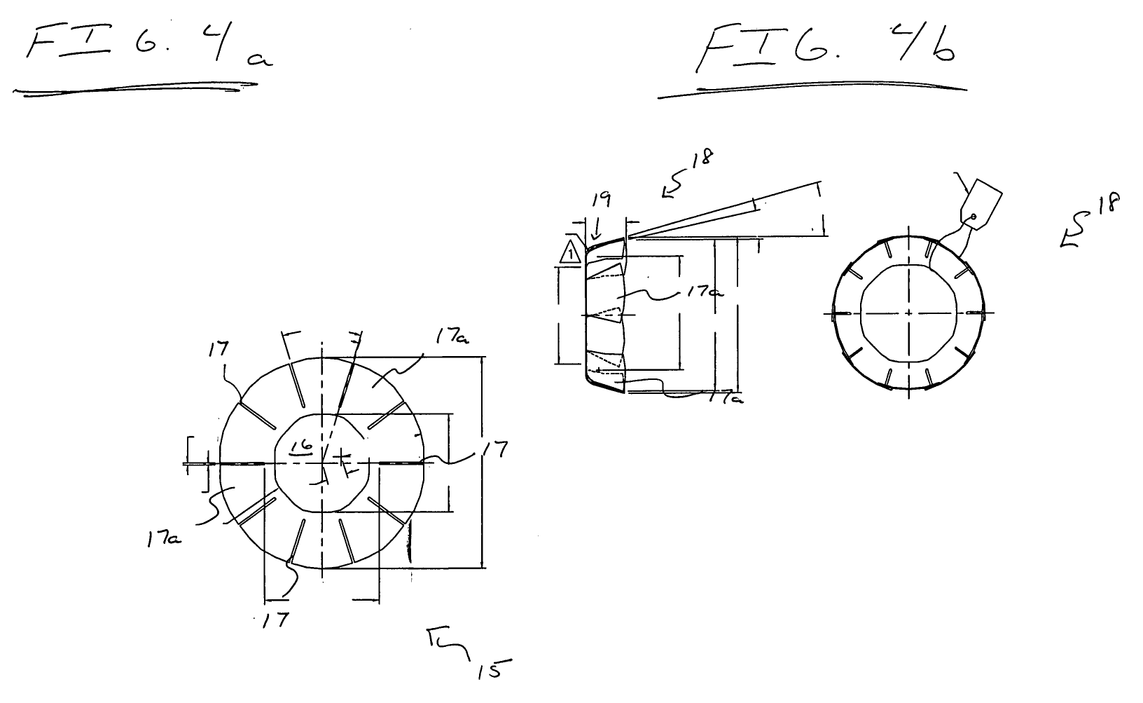

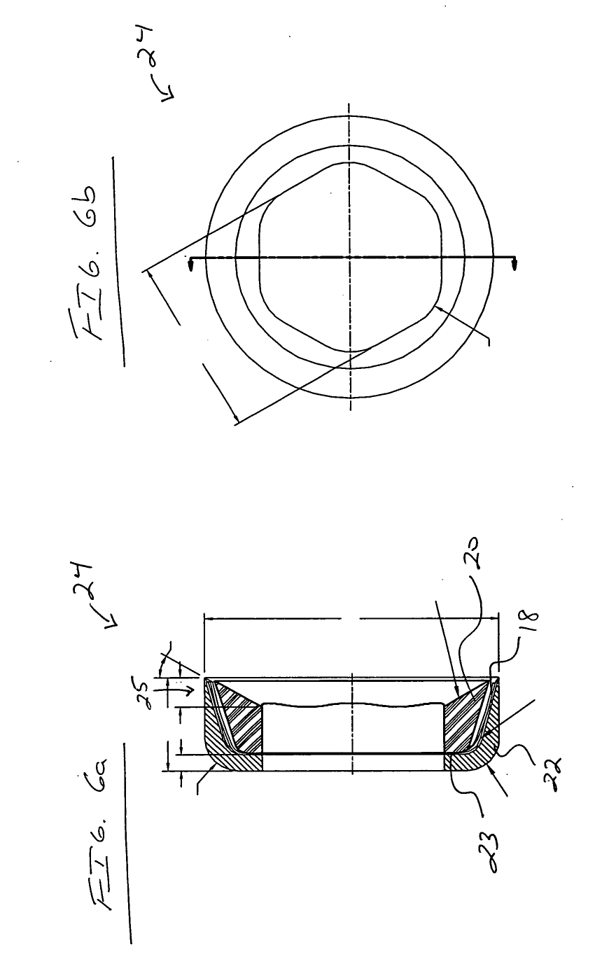

A second embodiment of the back-up apparatus of the present invention is illustrated in FIGS. 4(a-b) through FIGS. 6(a-b). FIG. 4a shows an overhead view of a flat metallic disc (15). The metallic disc (15) is preferably composed of steel, but any suitable metal may be used. In an alternative embodiment, the metallic disc (15) may be composed of a non-metallic material such as a sheet-molding compound, however any suitable non-metallic material may be used.

The metallic disc (15) includes a longitudinal bore (16), which in this embodiment exhibits a hexagonal shape, but may exhibit any other suitable polygonal shape. The shape of the bore (16) is again dependent on the shape of the corresponding mandrel (not shown) of the packer or bridge plug (not shown) onto which the back-up apparatus will eventually be placed.

The metallic disc (15) includes a series of slots (17), which extend radially from the outer diameter of the metallic disc (15) towards the longitudinal bore (16). The slots (17) extend completely through the outer metallic disc (15). The slots (17) effectively form a series of petals (17a) in the areas located between the slots (17). In FIG. 4a, ten slots (17) and corresponding petals (17a) are shown spaced equally around the metallic disc (15). However, a different number of slots (17) and petals (17a) spaced in a different manner may be acceptable. FIG. 4b shows the flat metallic disc (15) after the petals (17a) have been “crimped” and formed into a metallic ring (18). The metallic ring (18) exhibits a generally conical shape, but includes a flat shelf (not shown) extending radially inward at the narrow end (19) of the metallic ring (18). In this “crimped” state, the petals (17a) overlap each other, thereby effectively eliminating the slots (17).

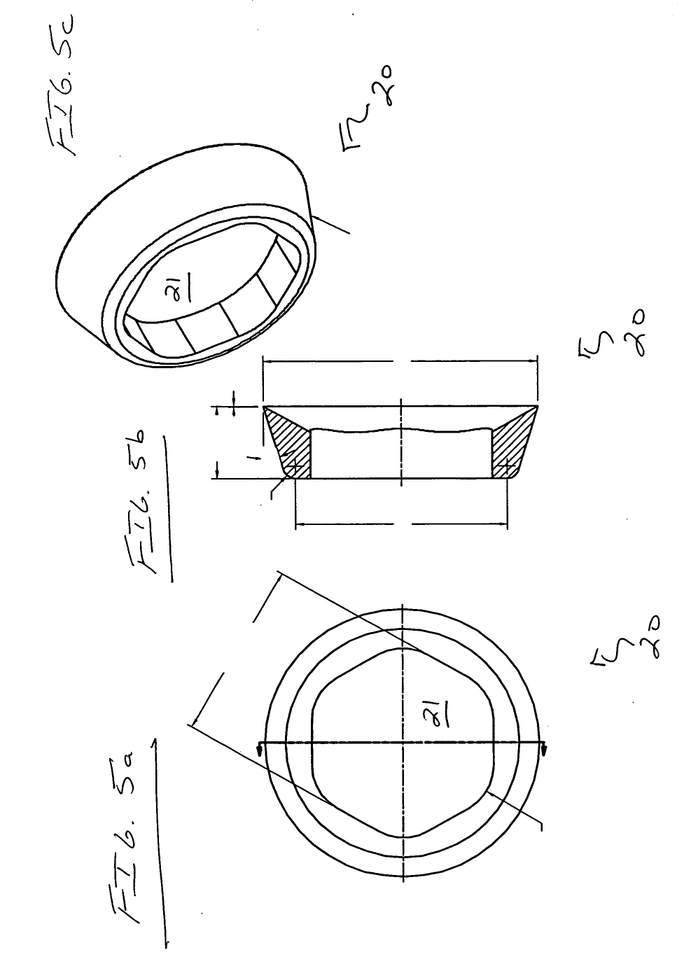

FIGS. 5a, 5b, and 5c show multiple views of a non-metallic inner ring (20). The non-metallic inner ring (20) is preferably composed of a non-elastomeric material such as PTFE, however any suitable non-metallic material may be used. In an alternative embodiment, the non-metallic inner ring (20) may be composed of a soft metal, such as lead, antimony, or brass. The non-metallic inner ring (20) exhibits a generally conical shape and includes a longitudinal bore (21), which in this embodiment exhibits a hexagonal shape, but may exhibit any other suitable polygonal shape. It is preferable for the shape of the longitudinal bore (21) of the inner non-metallic inner ring (20) to match the shape of the longitudinal bore (16) of the metallic ring (18). The inner metallic ring (as shown in FIGS. 5(a-c)) is placed within the metallic ring (as shown in FIG. 4b) such that the outer diameter of the inner non-metallic inner ring (20) abuts the inner diameter of the metallic ring (18). As the longitudinal bores (16, 21) exhibit the same geometry (as described above), they are aligned such that their respective shapes effectively mirror each other.

FIGS. 6a and 6b show multiple views of the non-metallic inner ring (20) placed within the metallic ring (18). FIGS. 6a and 6b also shows a non-metallic outer ring (22) placed around the outer diameter of the metallic ring (18). The non-metallic outer ring (22) is preferably composed of an elastomeric material such as nitrile rubber, but any suitable material can be used. While not entirely encapsulating the metallic ring (18) as in the first embodiment, the non-metallic outer ring (22) of this embodiment extends the entire longitudinal length of the metallic ring (18), including the shelf portion (23), and effectively flows through any gaps between the petals (17a) in the metallic ring (18). The concentric three rings (18, 20, 22) are preferably compression molded to each other thereby creating a mechanical bond, however any suitable bonding mechanism can be used, including chemically bonding the three rings (18, 20, 22) together. The three rings (18, 20, 22) comprise the complete back-up assembly (24).

To construct a typical packer or bridge plug using the back-up assembly (24) of this embodiment, one or more (usually two) back-up assemblies (24) are placed onto the mandrel (not shown) of the packer or bridge plug (not shown). The placement onto the mandrel is facilitated by the corresponding geometries of the mandrel and the longitudinal bores (16, 21), as described above. The back-up assemblies (24) are typically located on either side of a sealing member (not shown), with the wide end (25) of the back-up assemblies facing the sealing member. As before, the packer or bridge plug is further constructed using additional components such as slips, cones, locking rings, etc., all of which are known to those of skill in the art and thus are not described or illustrated here.

Once constructed, the packer or bridge plug is lowered into a wellbore. As with the encapsulation of the first embodiment, the non-metallic outer ring (22) of the present embodiment prevents damage to the metallic ring (18) and helps to ensure the packer or bridge plug reaches the proper depth. Once correctly positioned, the packer or bridge plug is activated (the activation sequence depending on the type of packer or bridge plug), which typically results in the longitudinal compression of the sealing member such that the sealing member is forced outwardly into contact with the wellbore casing.

Simultaneously, the metallic rings (18) of the back-up assemblies (24) flare out and expand radially (thereby deforming and typically destroying the non-metallic outer rings (22)) and prevent extrusion of the sealing member. The non-metallic inner rings (20) act as a bridging material between the sealing member and the metallic rings (18), and further prevent the extrusion of the sealing member. With reference to FIG. 4b, the overlapping of the “crimped” petals (17a) leaves little or no uncovered “gaps” as the metallic rings (18) are flared out. Accordingly, as the sealing member (not shown) expands, it is prohibited from extruding past the back-up assemblies (24), and is instead forced into sealing contact with the wellbore casing (not shown).

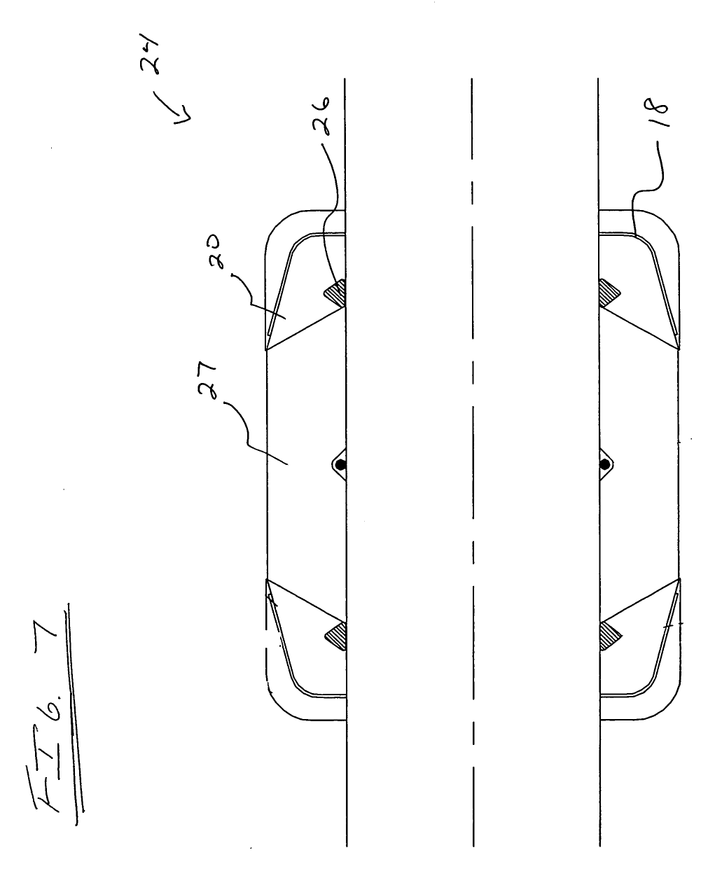

A third embodiment of the back-up assembly of the present invention is illustrated in FIGS. 7 through 9. FIG. 7 shows a cross-sectional view of the back-up assembly (24) as described above, however an additional anti-extrusion ring (26) has been added. The anti-extrusion ring (26) is preferably composed of a non-metallic material such as engineering grade plastic, but any suitable non-metallic material may be used. In an alternative embodiment, the anti-extrusion ring is composed of a metallic material such as steel, however any suitable metallic material may be used.

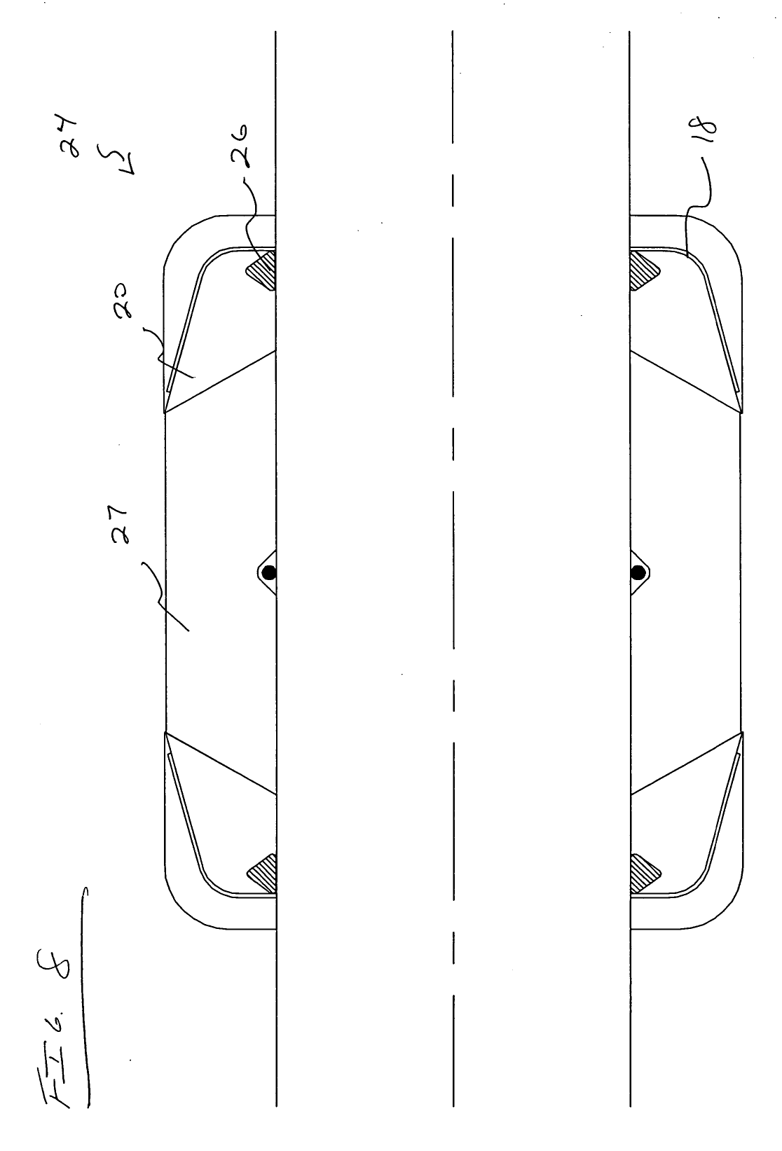

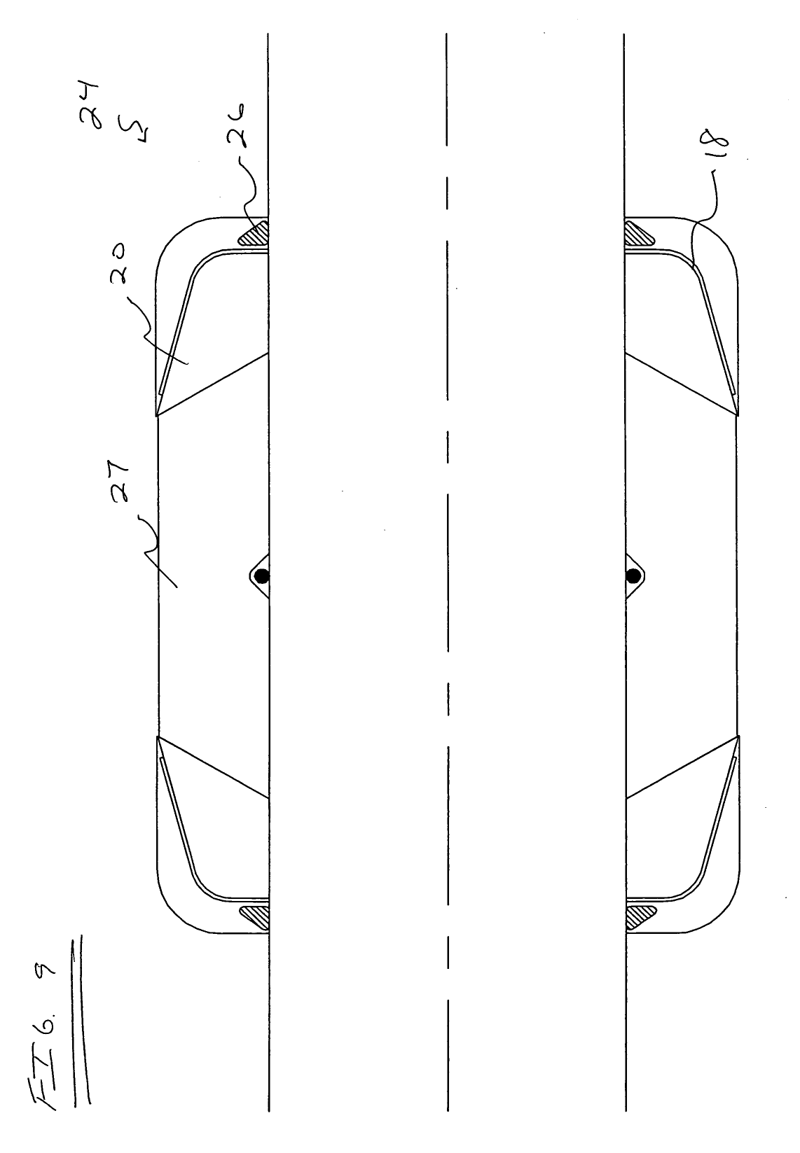

The anti-extrusion ring (26) is added to improve the anti-extrusion capability of the back-up assembly (24) at higher wellbore temperatures (i.e., temperatures at or above 300° Fahrenheit). In FIG. 7, the anti-extrusion ring (26) is embedded into the non-metallic inner ring (20) at a point adjacent to the sealing member (27). In an alternative embodiment shown in FIG. 8, the anti-extrusion ring (26) is embedded into the non-metallic inner ring (20) at a point adjacent to the metallic ring (18). In yet another alternative embodiment shown in FIG. 9, the anti-extrusion ring (26) is embedded into the non-metallic outer ring (22). In a final alternative embodiment (not shown), the anti-extrusion ring (26) is attached to the outer diameter of the non-metallic outer ring (22).

While preferred embodiments of the apparatus and methods have been discussed for purposes of this disclosure, numerous changes in the make-up, construction, and function of the back-up assembly of the present invention may be made by those skilled in the art. All such changes are encompassed within the scope and spirit of the following claims.

What is claimed is:

1. A back-up assembly for preventing the extrusion of a non-metallic seal, the assembly comprising:
a first metallic ring including a first series of longitudinal slots;
a second metallic ring including a second series of longitudinal slots, the second metallic ring attached to the first metallic ring such that the outer diameter of the second metallic ring abuts the inner diameter of the first metallic ring and the second series of longitudinal slots are not aligned with the first series of longitudinal slots; and
a non-metallic material encapsulating the first metallic ring and the second metallic ring.

2. The back-up assembly of claim 1, wherein the second metallic ring is attached to the first metallic ring by spot welding.

3. The back-up assembly of claim 1, wherein the non-metallic material encapsulating the first metallic ring and the second metallic ring is an elastomeric material.

4. The back-up assembly of claim 3, wherein the elastomeric material is nitrile rubber.

5. The back-up assembly of claim 1, wherein the non-metallic material encapsulating the first metallic ring and the second metallic ring is an non-elastomeric polymer.

6. The back-up assembly of claim 5, wherein the non-elastomeric polymer is PTFE.

7. The back-up assembly of claim 1, wherein the first metallic ring and the second metallic ring are comprised of steel.

8. The back-up assembly of claim 1, further comprising a centralized bore.

9. The back-up assembly of claim 8, wherein the centralized bore exhibits a polygonal shape.

10. A back-up assembly for preventing the extrusion of a non-metallic seal, the assembly comprising:
a first metallic ring including a first series of petals;
a second metallic ring including a second series of petals, the second metallic ring attached to the first metallic ring such that the outer diameter of the second metallic ring abuts the inner diameter of the first metallic ring and the second series of petals are offset from the first series petals; and
a non-metallic material encapsulating the first metallic ring and the second metallic ring.

11. The back-up assembly of claim 10, further comprising a centralized bore.

12. The back-up assembly of claim 11, wherein the centralized bore exhibits a polygonal shape.

13. A method of constructing a back-up assembly used for preventing the extrusion of a non-metallic seal, the method comprising:
providing a first metallic ring including a first series of longitudinal slots;
providing a second metallic ring including a second series of longitudinal slots,
placing the second metallic ring within the first metallic ring such that the outer diameter of the second metallic ring abuts the inner diameter of the first metallic ring;
arranging the second metallic ring within the first metallic ring such that the second series of longitudinal slots are not aligned with the first series of longitudinal slots; and
encapsulating the first metallic ring and the second metallic ring in a non-metallic material.

14. The method of claim 13, further comprising providing a centralized bore through the back-up assembly.

15. The method of claim 14, wherein the centralized bore exhibits a polygonal shape.

16. The method of claim 13, wherein the step of aligning the second metallic ring within the first metallic ring further comprises attaching the second metallic ring to the first metallic ring by spot welding.

17. A back-up assembly for preventing the extrusion of a non-metallic seal, the assembly comprising:
a crimped metallic ring including a series of overlapping petals;
a non-metallic inner ring attached to the inner diameter of the crimped metallic ring; and
a non-metallic outer ring attached to the outer diameter of the crimped metallic ring.

18. The back-up assembly of claim 17, further comprising a back-up ring attached to the inner diameter of the non-metallic inner ring.

19. The back-up assembly of claim 17, further comprising a back-up ring embedded in the non-metallic inner ring.

20. The back-up assembly of claim 17, further comprising a back-up ring embedded in the non-metallic outer ring.

21. The back-up assembly of claim 17, further comprising a back-up ring attached to the outer diameter of the outer non-metallic ring.

22. The back-up assembly of claim 17, wherein the crimped metallic ring is comprised of steel.

23. The back-up assembly of claim 17, wherein the non-metallic outer ring is comprised of an elastomeric material.

24. The back-up assembly of claim 23, wherein the elastomeric material is nitrile rubber.

25. The back-up assembly of claim 17, wherein the non-metallic inner ring is comprised of an non-elastomeric material.

26. The back-up assembly of claim 25, wherein the non-elastomeric material is PTFE.

27. The back-up assembly of claim 17, wherein the non-metallic outer ring is mechanically attached to the outer diameter of the crimped metallic ring.

28. The back-up assembly of claim 17, wherein the non-metallic outer ring is chemically attached to the outer diameter of the crimped metallic ring.

29. The back-up assembly of claim 17, wherein the non-metallic inner ring is mechanically attached to the inner diameter of the crimped metallic ring.

30. The back-up assembly of claim 17, wherein the non-metallic inner ring is chemically attached to the outer diameter of the crimped metallic ring.

31. The back-up assembly of claim 17, wherein the non-metallic outer ring is compression molded to the outer diameter of the crimped metallic ring.

32. The back-up assembly of claim 17, wherein the non-metallic inner ring is compression molded to the inner diameter of the crimped metallic ring.

33. A method of constructing a back-up assembly used for preventing the extrusion of a non-metallic seal, the method comprising:
providing a crimped metallic ring including a series of overlapping petals;
attaching a non-metallic inner ring to the inner diameter of the crimped metallic ring; and
attaching a non-metallic outer ring to the outer diameter of the crimped metallic ring.

34. The method of claim 33, further comprising attaching a back-up ring to the inner diameter of the inner non-metallic ring.

35. The method of claim 33, further comprising embedding a back-up ring within the inner non-metallic ring.

36. The method of claim 33, further comprising embedding a back-up ring within the outer non-metallic ring.

37. The method of claim 33, further comprising attaching a back-up ring to the outer diameter of the outer non-metallic ring.

38. The method of claim 33, further comprising mechanically bonding the non-metallic inner ring and the non-metallic outer ring to the crimped metallic ring.

39. The method of claim 33, further comprising chemically bonding the non-metallic inner ring and the non-metallic outer ring to the crimped metallic ring.

40. A back-up assembly for preventing the extrusion of a non-metallic seal, the assembly comprising:
a crimped metallic ring including a series of overlapping petals;
a metallic inner ring attached to the inner diameter of the crimped metallic ring; and
a non-metallic outer ring attached to the outer diameter of the crimped metallic ring.

41. The back-up assembly of claim 40, further comprising a back-up ring attached to the inner diameter of the non-metallic inner ring.

42. The back-up assembly of claim 40, further comprising a back-up ring embedded in the non-metallic inner ring.

43. The back-up assembly of claim 40, further comprising a back-up ring embedded in the non-metallic outer ring.

44. The back-up assembly of claim 40, further comprising a back-up ring attached to the outer diameter of the outer non-metallic ring.

45. The back-up assembly of claim 40, wherein the non-metallic outer ring is comprised of nitrile rubber.

46. The back-up assembly of claim 40, wherein the metallic inner ring is comprised of brass.

47. A method of constructing a back-up assembly used for preventing the extrusion of a non-metallic seal, the method comprising:
providing a crimped metallic ring including a series of overlapping petals;
attaching a metallic inner ring to the inner diameter of the crimped metallic ring; and
attaching a non-metallic outer ring to the outer diameter of the crimped metallic ring.

48. The method of claim 47, further comprising attaching a back-up ring to the inner diameter of the inner non-metallic ring.

49. The method of claim 47, further comprising embedding a back-up ring within the inner non-metallic ring.

50. The method of claim 47, further comprising embedding a back-up ring within the outer non-metallic ring.

51. The method of claim 47, further comprising attaching a back-up ring to the outer diameter of the outer non-metallic ring.

52. The method of claim 47, further comprising mechanically bonding the non-metallic inner ring and the non-metallic outer ring to the crimped metallic ring.

53. The method of claim 47, further comprising chemically bonding the non-metallic inner ring and the non-metallic outer ring to the crimped metallic ring.

54. A back-up assembly for preventing the extrusion of a non-metallic seal, the assembly comprising:
a first metallic ring including a first series of petals;
a second metallic ring including a second series of petals, the second metallic ring attached to the first metallic ring such that the outer diameter of the second metallic ring abuts the inner diameter of the first metallic ring and the second series of petals are offset from the first series petals; and
a non-metallic material encapsulating the first metallic ring.

55. The back-up assembly of claim 54, further comprising a centralized bore.

56. The back-up assembly of claim 55, wherein the centralized bore exhibits a polygonal shape.

57. A method of constructing a back-up assembly used for preventing the extrusion of a non-metallic seal, the method comprising:
providing a first metallic ring including a first series of longitudinal slots;
encapsulating the first metallic ring in a non-metallic material;
providing a second metallic ring including a second series of longitudinal slots,
placing the second metallic ring within the first metallic ring such that the outer diameter of the second metallic ring abuts the inner diameter of the first metallic ring; and
arranging the second metallic ring within the first metallic ring such that the second series of longitudinal slots are not aligned with the first series of longitudinal slots.

58. The method of claim 57, further comprising providing a centralized bore through the back-up assembly.

59. The method of claim 58, wherein the centralized bore exhibits a polygonal shape.

60. A back-up assembly for preventing the extrusion of a non-metallic seal, the assembly comprising:
a first non-metallic ring including a first series of petals;
a second non-metallic ring including a second series of petals, the second non-metallic ring attached to the first non-metallic ring such that the outer diameter of the second non-metallic ring abuts the inner diameter of the first non-metallic ring and the second series of petals are offset from the first series petals; and
a non-metallic material encapsulating at least one of the non-metallic rings.

61. A method of constructing a back-up assembly used for preventing the extrusion of a non-metallic seal, the method comprising:
providing a first non-metallic ring including a first series of longitudinal slots;
providing a second non-metallic ring including a second series of longitudinal slots,
placing the second non-metallic ring within the first non-metallic ring such that the outer diameter of the second non-metallic ring abuts the inner diameter of the first non-metallic ring;
arranging the second non-metallic ring within the first non-metallic ring such that the second series of longitudinal slots are not aligned with the first series of longitudinal slots; and
encapsulating the first non-metallic ring and the second non-metallic ring in a non-metallic material.

62. A back-up assembly for preventing the extrusion of a non-metallic seal, the assembly comprising:
a crimped non-metallic ring including a series of overlapping petals;
a non-metallic inner ring attached to the inner diameter of the crimped non-metallic ring; and
a non-metallic outer ring attached to the outer diameter of the crimped non-metallic ring.

63. The back-up assembly of claim 62, further comprising a back-up ring attached to the inner diameter of the non-metallic inner ring.

64. The back-up assembly of claim 62, further comprising a back-up ring embedded in the non-metallic inner ring.

65. The back-up assembly of claim 62, further comprising a back-up ring embedded in the non-metallic outer ring.

66. The back-up assembly of claim 62, further comprising a back-up ring attached to the outer diameter of the outer non-metallic ring.

67. The back-up assembly of claim 62, wherein the crimped non-metallic ring is comprised of a sheet-molding compound.

68. A method of constructing a back-up assembly used for preventing the extrusion of a non-metallic seal, the method comprising:
providing a crimped non-metallic ring including a series of overlapping petals;
attaching a non-metallic inner ring to the inner diameter of the crimped non-metallic ring; and
attaching a non-metallic outer ring to the outer diameter of the crimped non-metallic ring.

69. The method of claim 68, further comprising attaching a back-up ring to the inner diameter of the inner non-metallic ring.

70. The method of claim 68, further comprising embedding a back-up ring within the inner non-metallic ring.

71. The method of claim 68, further comprising embedding a back-up ring within the outer non-metallic ring.

72. The method of claim 68, further comprising attaching a back-up ring to the outer diameter of the outer non-metallic ring.
